(19) United States
(12) Patent Application Publication
(10) Pub. No.: US 2016/0001331 A1
(43) Pub. Date: Jan. 7, 2016

(54) PRESSURIZED MOBILE WASHER INCLUDING DE-IONIZED WATER CLEANING AEROSOL AND HOUSING CANISTER

(71) Applicants: ALIREZA ALAVIAN, MISSION VIEJO, CA (US); BANAFSHEH ALAVIAN, MISSION VIEJO, CA (US)

(72) Inventors: ALIREZA ALAVIAN, MISSION VIEJO, CA (US); BANAFSHEH ALAVIAN, MISSION VIEJO, CA (US)

(21) Appl. No.: 14/793,505

(22) Filed: Jul. 7, 2015

Related U.S. Application Data
(60) Provisional application No. 62/021,616, filed on Jul. 7, 2014.

(51) Int. Cl. B08B 3/02; B65D 83/42; B65D 83/14; B65D 83/28

(52) U.S. Cl. CPC B08B 3/02; B65D 83/28; B65D 83/42; B65D 83/752

(57) ABSTRACT

A pressurized washing apparatus includes an aerosol comprised of a solution of de-ionized or distilled water that is dispensed with pressure from a canister to lift away dirt or debris from surfaces of articles or items toward which it is directed. The solution of de-ionized or distilled water ensures that surfaces will air-dry without risk of leaving any mineral or calcium build-up, residue, or film behind. The aerosol is housed in a canister-based product that helps with vehicular upkeep so that the vehicle will be clean of spots, droppings, tree sap and other elements between car washes. The aerosol also enables users to wash hands and clean many other surfaces that require the removal of dirt using a cleaning aide or water under pressure where sources of water may not be available.

### CROSS-REFERENCE TO RELATED APPLICATION(S)

This patent application claims priority to U.S. provisional application 62/021,616, filed on Jul. 7, 2014, the contents of which are incorporated in their entirety herein. In accordance with 37 C.F.R. §1.76, a claim of priority is included in an Application Data Sheet filed concurrently herewith.

### FIELD OF THE INVENTION

The present invention relates to mobile cleaning solutions provided by a pressurized washer that is housed within a canister. Specifically, the present invention relates to a cleaning aerosol and solution that is housed within, and dispensed from, a pressurized canister, for the purpose of cleaning surfaces of items such as inside and outside vehicles, and for cleaning other items such as a person's body or apparel where no other suitable fluid source of water is available.

### BACKGROUND OF THE INVENTION

There are many types of existing products, devices, and systems available that employ water in some form as a solution for cleaning items such as vehicular surfaces. These can be grouped into several categories according to the concepts disclosed therein. For example, there are many existing portable/mobile pressurized water dispensation systems that utilize de-ionized, de-mineralized, or purified water for cleaning vehicular surfaces. There are also many multi-component vehicular cleaning systems that utilize, for example, de-ionized water or pressurized steam from distilled water.

Additionally, there are many spraying devices that specifically involve cleaning compositions together with some type of purified or de-ionized water, wherein the spraying devices have specific, particular configurations. There are also many other general cleaning systems or other liquid-spraying systems that can be used to dispense water onto surfaces.

However, none of these existing products, devices, and systems disclose a vehicular cleaning system which employs an aerosol comprised of distilled water that is housed within, and dispensed from, a pressurized canister. Additionally, none of these existing products, devices, or systems disclose a vehicular cleaning system which employs a solution capable of cleaning surfaces of vehicles or other items without leaving any residue on the surface.

### BRIEF SUMMARY OF THE INVENTION

Accordingly, it is one objective of the present invention to provide a pressurized water system for cleaning vehicular and other surfaces. It is another objective of the present invention to provide a canister for dispensing a cleaning aerosol and solution for vehicular and other surfaces that does not leave any film or residue. It is still another objective of the present invention to provide a canister-based de-ionized or distilled water aerosol and solution that is dispensed under pressure for cleaning vehicular and other surfaces. It is a further objective of the present invention to provide a pressurized water system for removing stains or unwanted material from the body, from apparel, or from any item or surface for which other cleaning solutions are not readily available or practical.

In one embodiment of the present invention, an apparatus comprises an aerosol comprising a solution of water housed within a pressurized canister, the solution of water comprised of either distilled water or de-ionized water, and a spray nozzle configured to dispense the solution of water in a selectable pattern for application to a specific treatment area, the solution of water dispensed at a sustained pressure level of between 110 PSI and 130 PSI. The apparatus delivers the solution of water to a surface of an article or item having the treatment area so that the surface remains free of residue or film after treatment is completed.

In another embodiment of the present invention, a cleaning system for vehicular surfaces comprises a pressurized canister housing a water-based aerosol and having a configurable spray nozzle for delivering the water-based aerosol from the pressurized canister to a treatment area on a vehicular surface, and a sustained pressure level at which the water-based aerosol is dispensed from the pressurized canister. The sustained pressure level and the water-based aerosol ensure that a vehicular surface dries free of any residue left behind on the vehicular surface after delivery to the treatment area.

In yet another embodiment of the present invention, an aerosol for cleaning surfaces comprises a water solution housed within a pressurized canister, the water solution dispensed from the pressurized canister at a sustained pressure level of between 110 PSI and 130 PSI and in a selectable pattern, so that when the water solution is applied to a treatment area on a surface, the selectable pattern restricts application of the water solution to the treatment area and the surface remains free of residue.

Other objects, embodiments, features and advantages of the present invention will become apparent from the following description of the embodiments, which illustrate, by way of example, the principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a view of a pressurized canister housing an aerosol and water cleaning solution according to the present invention;

FIG. 2 is another view of a pressurized canister according to the present invention;

FIG. 3 is another view of components of a pressurized canister according to the present invention;

FIG. 4 is a view of a pressurized canister showing a spray pattern according to one embodiment of the present invention; and

FIG. 5 is a close-up view of an actuator as part of a pressurized canister according to the present invention.

### DETAILED DESCRIPTION OF THE INVENTION

In the following description of the present invention reference is made to the exemplary embodiments illustrating the principles of the present invention and how it is practiced. Other embodiments will be utilized to practice the present invention and structural and functional changes will be made thereto without departing from the scope of the present invention.

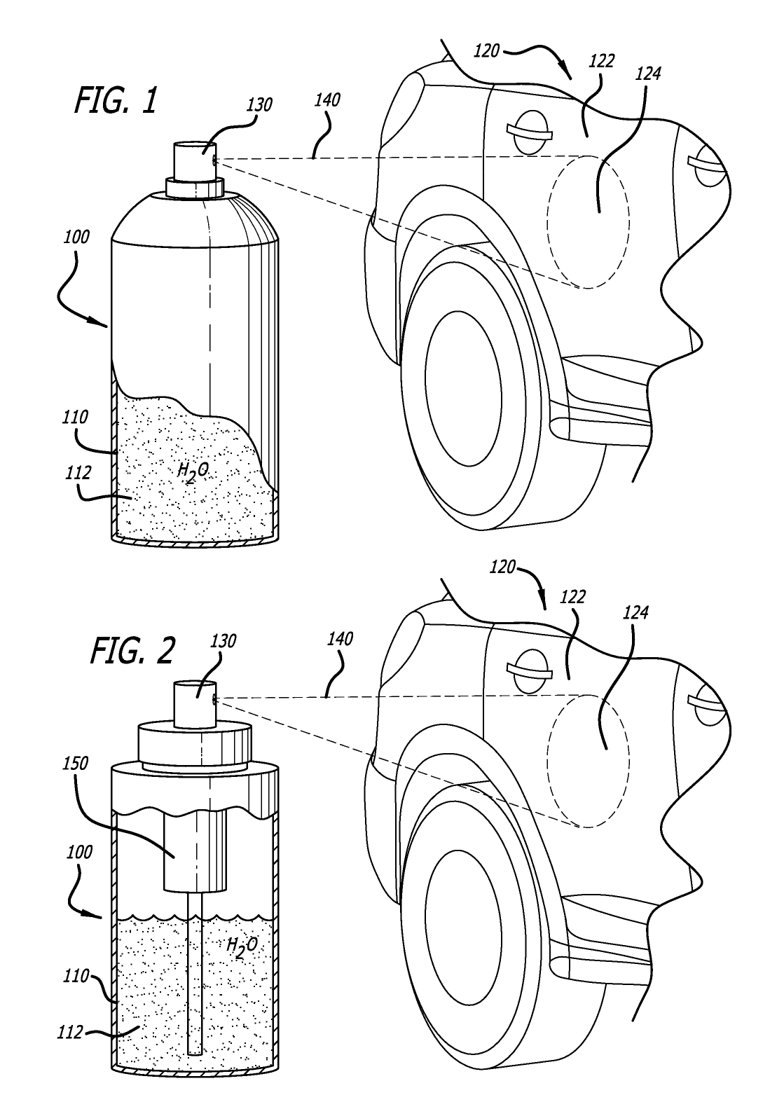

FIG. 1 is a perspective view of the present invention, which provides a pressurized washing apparatus housed in a portable container. The present invention includes a pressurized, portable canister 100, housing an aerosol 110 comprised of a solution 112 according to the present invention. The aerosol 110 is, according to one embodiment of the present invention, comprised of a solution of de-ionized or distilled water 112, and is dispensed with pressure from the pressurized canister 100 to lift away dirt, debris, or other unwanted material from a surface 122 of an article or item 120 toward which it is directed. The de-ionized or distilled water solution 112 ensures that the treated area 124 will air-dry without a risk of leaving any mineral or calcium build-up behind on the surface 122.

The pressurized canister 100 is a stand-alone product produced under the name AquaJet or Aqua Jet, that is intended to offer a mobile solution to clean surfaces 122, such as those on vehicles, were other sources of water or cleaner are not available. For example, one intended use of the de-ionized or distilled water solution 112 is to help with vehicular upkeep so that interior and exterior vehicular surfaces 122 will be clean of spots, dirt, droppings, tree sap and other such elements, between washes or cleanings.

As noted above, the de-ionized or distilled water solution 110 is dispensed under pressure to ensure that enough force is applied to the spots, debris, dirt, droppings, tree sap and other such elements to adequately remove them from the surface 122 being cleaned. An amount of pressure with which the solution 112 is optimized for particular uses of the aerosol 110, such as for example between 110-130 PSI (pounds per square inch). Other ranges of pressure values are also contemplated, such as for example between 90-110 PSI, and it is to be noted that many different ranges can be employed to achieve the intended results and purposes of the present invention. By way of further example, the amount of pressure with which the solution 112 is dispensed may be optimized for particular uses of the product, for treating a particular kind of surface 122, or for treating a particular kind of debris. Therefore, the scope of the present invention is not intended to be limited by any specific pressure range disclosed herein. It is further contemplated that the present invention may be configured to provide a particular sustained and uniform pressure, such as 130 PSI, so that the same or nearly the same pressure is delivered at each usage.

The present invention may also be configured so that the pressure is adjustable, and therefore means are contemplated that enable users to manually adjust the pressure upon each use to deliver a specifically-desired pressure. The scope of the present invention is also not intended to be limited to any specific pressure disclosed herein, nor any specific means for adjustment.

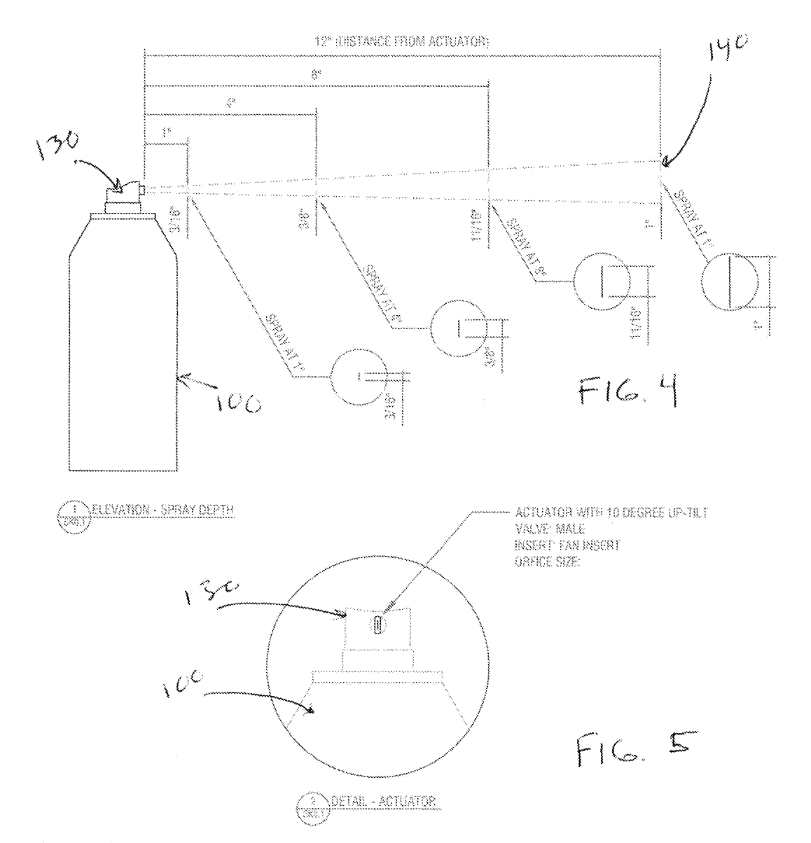

The pressurized canister 100 may include an actuator 130 that includes a spraying nozzle or other apparatus from which the present invention is actuated, or from which the de-ionized or distilled water solution 112 comprising the aerosol 110 is dispensed, or both. The actuator 130 may be configured to dispense the de-ionized or distilled water solution 112 in a specific manner or in a specific disbursement pattern, such as for example in a “fan” pattern 140 as shown in FIG. 4, so that the sprayed dispensation covers a particular area 124 of the surface 122 to which it is applied. FIG. 5 is a close-up view of the actuator 130 according to one embodiment of the present invention.

The actuator 130 includes components configured to dispense the de-ionized or distilled water solution 110 in other specific disbursement patterns or manners, such as in a line format, so that the sprayed dispensation covers about one inch and a half of the surface 122 to which it is applied. This allows for a concentrated coverage of a larger area or spots and the like more easily, by targeting specific areas or items therein instead of a circular format that is less concentrated. The dispensation area may be customizable by manipulating the actuator 130, so that the treated area 124 may be larger or smaller.

The actuator 130 also includes components configured to generate the specific disbursement pattern from the spraying nozzle, and further components configured to initiate mixing of a propellant agent and solution comprising the aerosol 110 in the canister 100 at a particular speed before dispensation from the canister 100. In this manner the actuator 130 enables the present invention to be a pressure washer housed in the canister 100 where a substantially uniform pressure is carried all the way through from mixing inside the canister 100 to application to a desired surface 122.

It is to be noted that the substantially uniform pressure remains constant within certain tolerances from mixing by the actuator 130 to application to the desired surface 122. In this manner the pressure may be thought of as sustained within a certain range, and though is to be understood that some pressure loss may be realized from mixing to application, the pressure applied is contemplated be substantially the same as the pressure generated by the actuator 130 and within a pressure desired by the user.

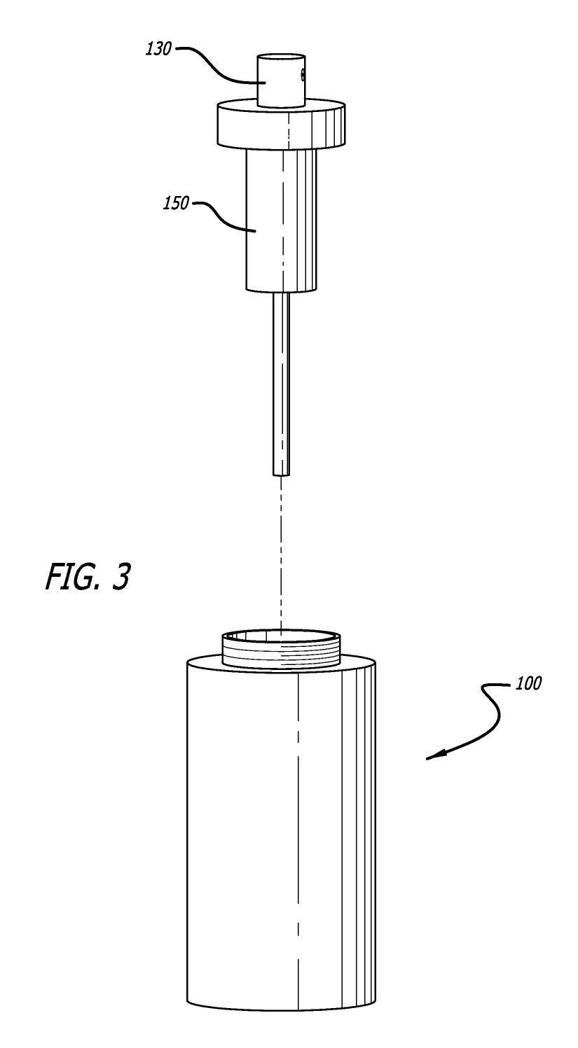

FIG. 2 and FIG. 3 show the canister 100 configured with a pump 150. In one embodiment of the present invention, the pressurized canister 100 may be refillable by a user to create the same, close to the same, or a customized pressure level. The user can restore the level as pressure decreases with use or with a diminishing amount of solution inside the pressurized canister 100. The user may employ, for example, a pump 150 to refill the pressurized canister 100, and may also be able to set, or adjust as noted above, the amount or level of pressure of the aerosol 110 inside the canister 100 using an aerosol pressure setting component, depending upon the user's need or the amount of solution contained within the pressurized canister 100. In another embodiment of the present invention, the amount of solution 112 comprising the aerosol 110 in the pressurized canister 100 may also be refillable by a user to create the same, close to the same, or customized level of solution therein.

In another embodiment, refilling a pressurized canister 100 may also be accomplished with a bag-on-valve configuration that allows for the solution 112 to be placed in a bag that is directly attached to a valve. Such a configuration may be utilized with a tube inside the bag which draws the solution 112 out to the actuator. A propellant agent inside the canister 100 creates pressure against the bag and each time the actuator is activated or pressed, the propellant agent will propel the solution 112 out without the aerosol being released at the same time. Therefore the pressure is maintained for a more sustained or uniform pressure.

In still another embodiment of the present invention, the pressurized canister 100 may be configured so that user is not able to refill, reset or restore the amount of pressure therein. Similarly, the pressurized canister 100 may also be configured so that the amount of solution 112 comprising the aerosol 110 cannot be refilled by the user.

In addition to the interior and exterior vehicular uses noted above, many other vehicular uses are contemplated. Examples include removing excess brake dust from wheels and tires, cleaning spillages from overflow gasoline from paint, and cleaning floor mats of undesirable items. It is also to be noted that the de-ionized or distilled water solution 112 and the canister 100 are contemplated to have many other uses beyond treatment of surfaces 122 of articles such as vehicles. For example, the present invention may be used for washing hands, and cleaning parts or surfaces of motorbikes, bicycles, and many other items that require the removal of dirt using a cleaning aide or water under pressure. One benefit of the many uses of the present invention is its utility where sources of water are not readily available, and yet where the user still wishes to thoroughly clean an article or item in a way that does not leave a film or residue thereon.

Exemplary uses of the present invention include removing bird droppings from any surfaces 122 (such as the exterior of a vehicle or boat), and removing small stains or spills on interior surfaces such as the dashboard, car seats, and console areas between seats. Other exemplary non-vehicular uses are contemplated to include uses during camping to clean items such as utensils or cooking supplies, during mountain biking to cleanse bicycle components, rinsing off feet so that they are free of sand after a visit to the beach, washing ones shoe off after having stepped in mud or waste matter, and cleaning off baby products, glass ware, and china ware, as well as cleaning food items such as fruits and vegetables when on a picnic, when camping, or right after purchase. To that end, it is further contemplated that the de-ionized or distilled water solution 112, and pressurized canister 100, is suitable for use with food and other products for eating or carrying food, and therefore may be used in environments where products fit for human consumption are present. The present invention may therefore be considered as “food grade” and usable as a source of clean water for washing food and also for drinking to quench one's thirst. Other uses may include watering hard to reach plants.

The present invention may also be used to clean and wash pets or remove residue from pet waste from places such as public sidewalks. To that end, it is to be noted that solution 112 is free of chemicals and other environmentally harmful elements, and therefore safe for use in public places without contaminating water or soil.

Many other industrial uses are possible. It is to be understood the present invention may be used in any industrial environment where a surface 122 or item needs to be quickly without using a large amount of water, or where cleaning solutions are either impractical or not available. The present invention may be used in any business setting where small quantities of pressurized water are needed. For example, workers on an oil or gas drilling platform may carry the pressurized canister 100 with them to quickly clean themselves, their clothing, their eyewear, or footwear when coming into contact with chemicals or other substances that are used in or are the by-product of such drilling activities. The present invention may also be used to clean equipment or machinery in such a “field” or remote environment, such as for example in rail and roadway maintenance and in construction settings such as roofing. International aid and medical workers may use the present invention as a clean source of water where it is otherwise very limited, and film professionals may utilize the present invention on location during filming. It is further contemplated that hunters or fisherman may also utilize the present invention as a clean source of water when in the field or when fishing.

It is further to be noted that other types or formulations of a water-based solution 112 comprising the aerosol 110 may also be housed within the canister 100, to accomplish the objective of treating surfaces 122 of articles and other items by removing particles or otherwise cleaning them without leaving any film, residue, or material on the surface 122. Examples of other types of water-based solution 112 include de-ionized water, purified water, iodized water, partially iodized water, or any other water solution that accomplishes the objectives of the present invention. Water may also be used in combination with other fluids, such as chemicals, minerals, or any other liquid to be used for cleaning surfaces 122 of articles and items, to dispense an appropriate cleaning solution 112 from the pressurized canister 100.

The foregoing descriptions of embodiments of the present invention have been presented for the purposes of illustration and description. It is not intended to be exhaustive or to limit the invention to the precise forms disclosed. Accordingly, many alterations, modifications and variations are possible in light of the above teachings, may be made by those having ordinary skill in the art without departing from the spirit and scope of the invention. It is therefore intended that the scope of the invention be limited not by this detailed description. For example, notwithstanding the fact that the elements of any claim herein are set forth below in a certain combination, it must be expressly understood that the invention includes other combinations of fewer, more or different elements, which are disclosed in above even when not initially or eventually claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in any claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. An apparatus comprising:
an aerosol comprising a solution of water housed within a pressurized canister, the solution of water comprised of either distilled water or de-ionized water; and
an actuator configured to dispense the solution of water in a selectable pattern for application to a specific treatment area, the solution of water dispensed at a substantially uniform pressure level of between 110 PSI and 130 PSI,
wherein the apparatus delivers the solution of water to a surface of an article or item having the treatment area so that the surface remains free of residue or film after treatment is completed.

2. The apparatus of claim 1, further comprising an aerosol setting component configure to perform at least one of adjustment of the substantially uniform pressure level or a restoration of the substantially uniform pressure level.

3. The apparatus of claim 1, wherein the actuator includes a spray nozzle that enables a plurality of configurations to change the selectable pattern.

4. The apparatus of claim 1, wherein the selectable pattern forms a shape of fan when the solution of distilled water is dispensed to the treatment area.

5. The apparatus of claim 1, further comprising a pump for refilling the pressurized canister with the aerosol.

6. A cleaning system for vehicular surfaces, comprising:
a pressurized canister housing a water-based aerosol and having a configurable actuator for delivering the water-based aerosol from the pressurized canister to a treatment area on a vehicular surface;
a substantially uniform pressure level at which the water-based aerosol is dispensed from the pressurized canister,
wherein the substantially uniform pressure level and the water-based aerosol ensure that a vehicular surface dries free of any residue left behind on the vehicular surface after delivery to the treatment area.

7. The system of claim 6, wherein the substantially uniform pressure level is between 110 PSI and 130 PSI.

8. The system of claim 6, wherein the substantially uniform pressure level is 130 PSI.

9. The system of claim 6, further comprising an aerosol setting component configure to adjust the substantially uniform pressure level.

10. The system of claim 6, further comprising an aerosol setting component configure to restore the substantially uniform pressure level.

11. The system of claim 6, wherein the actuator delivers the water-based aerosol from the pressurized canister in a selectable pattern, and includes a plurality of configurations to change the selectable pattern.

12. The system of claim 11, wherein the selectable pattern forms a shape of fan when the solution of distilled water is dispensed to the treatment area.

13. The system of claim 6, further comprising a pump for refilling the pressurized canister with the water-based aerosol.

14. The system of claim 6, wherein the water-based aerosol is one of a distilled water solution or a de-ionized water solution.

15. An aerosol for cleaning surfaces, comprising:
a water solution housed within a pressurized canister, the water solution dispensed from the pressurized canister at a substantially uniform pressure level of between 110 PSI and 130 PSI and in a selectable pattern, so that when the water solution is applied to a treatment area on a surface, the selectable pattern restricts application of the water solution to the treatment area and the surface remains free of residue.

16. The aerosol of claim 15, wherein the canister further includes an aerosol setting component configure to adjust and restore the substantially uniform pressure level.

17. The aerosol of claim 15, further comprising an actuator that includes a plurality of configurations to change the selectable pattern for application of the water solution.

18. The aerosol of claim 15, wherein the selectable pattern forms a shape of fan when the water solution is dispensed to the treatment area.

19. The aerosol of claim 15, further comprising a pump for refilling the pressurized canister with the water solution.

20. The aerosol of claim 15, wherein the water solution is one of a distilled water solution or a de-ionized water solution.
